(19) United States
(12) Patent Application Publication
(10) Pub. No.: US 2016/0059351 A1
(43) Pub. Date: Mar. 3, 2016

(54) LASER BEAM MACHINING APPARATUS WITH HIGH-SPEED POSITIONING FUNCTION

(71) Applicant: FANUC Corporation, Yamanashi (JP)

(72) Inventors: Kouichi MIYASHITA, Yamanashi (JP); Takeshi MOCHIDA, Yamanashi (JP)

(21) Appl. No.: 14/831,238

(22) Filed: Aug. 20, 2015

(30) Foreign Application Priority Data
Aug. 27, 2014 (JP) 2014-173108

(51) Int. Cl. B23K 26/08; B23K 26/36

(52) U.S. Cl. CPC B23K 26/0892; B23K 26/0823; B23K 26/36

(57) ABSTRACT

When an operation is performed in a direction (Z-axis direction) in which a machining head is brought closer to workpiece, a numerical controller that controls a laser beam machine avoids a collision of the machining head with the workpiece by switching to gap control when a gap sensor detects a gap amount between the machining head and the workpiece. At this point, whether to perform the operation to bring the machining head closer to the workpiece by gap control using a detection value of the gap sensor or by moving the machining head to a position determined by parameters can be selected using a mode switching unit.

### BACKGROUND OF THE INVENTION

1. Field of the Invention

The present invention relates to a laser beam machine with a high-speed positioning function.

2. Description of the Related Art

In machining by a laser beam machine, a technology is known that automatically retreats a machining head from workpiece at a machining end point and brings the machining head closer to the workpiece as the next machining point comes closer, in order to move from the machining end point to the next machining point at high speed while avoiding obstacles. In this conventional technology, control is exercised according to a lifting/descending speed, a retreating position, a descent start position, and a deceleration start position set to parameters to lift or descend the machining head at high speed.

When the machining head is caused to descend from the descent start position by the control based on a signal from a gap sensor, the descending speed is slowed and so the machining head descends at the descending speed set to parameters till the deceleration start position. The control based on the signal output from the gap sensor becomes effective after the machining head reaches the deceleration start position.

FIG. 7 shows a moving method of the machining head disclosed by JP 2004-1067 A.

After a machining head 40 reaches a machining end point Pe of a machining shape, the machining head 40 moves along a locus Lh of the machining head 40. That is, the machining head 40 is moved upward (Z-axis direction) by a predetermined amount at a predetermined speed and when the machining head 40 reaches a predetermined height, X and Y axes are moved in a machining start direction of the next machining shape. When a descending start position P1 is reached, the machining head 40 starts to descend toward the next machining start position (next machining start point Ps) of the workpiece. When the machining head is caused to approach the next machining start position, for example, the machining head 40 is brought closer to the vicinity of the next machining start position and when the deceleration start position is reached, the machining head 40 is moved to a desired machining position while avoiding a collision of the machining head 40 and workpiece 44 using a gap sensor (not shown) that measures a physical quantity in accordance with the distance (gap amount) between the machining head 40 and the workpiece 44.

However, the above technology does not take uses other than flattening into consideration and is intended to position plane axes (X-Y axes). Thus, problems as described below arise:

(I) When the machining head is brought closer to the workpiece, the machining head is descended to the position determined by parameters and thus, if the height (Z-axis direction) of the workpiece is different (that is, if the height of the workpiece changes at some midpoint), there is the danger of a collision with the workpiece. There are some cases in which, due to deflection or the like of the workpiece 44, as shown in FIG. 8, the next machining start position is higher than the machining end position (machining end point Pe). In such a case, according to the conventional technology, if the next machining start position (after the end position of positioning) is high, the machining head 40 collides with the workpiece 44 when the machining start position comes closer due to the deceleration start position of the machining head determined by parameter settings.
(II) In addition, the positioning command to a machining point in the next block cannot be applied to laser machining of pipe-shaped workpiece fixed to a rotation axis (workpiece in a shape in which the distance from a rotation center O to the outer circumferential surface is different around the rotation axis) because only plane axes (X and Y axes) are taken into consideration. When a machining surface is changed in pipe machining, as shown in FIG. 9, commands are issued in the following procedure:

(1) Cancel gap control once.

(2) Retreat the machining head.

(3) Change the machining surface.

(4) Reactivate the gap control.

To solve the problem in (I), a laser beam machining apparatus described in JP 2008-110389 A attempts to prevent a collision between a machining head and workpiece by bringing the machining head closer to the workpiece while activating gap control when the machining head is brought closer to the workpiece and stopping the machining head when the workpiece is detected.

However, the above laser beam machining apparatus stops the machining head when the workpiece is detected and therefore, a case where the height of the workpiece changes from time to time (see FIG. 9) cannot be handled.

### SUMMARY OF THE INVENTION

In view of the above problems of the conventional technology, an object of the present invention is to provide a laser beam machine capable of preventing a collision of a machining head with workpiece when a height direction of the workpiece to be machined is different or when the workpiece mounted on a rotation axis is machined.

A laser beam machine according to the present invention includes a gap sensor that detects a gap amount between a machining head and workpiece, a gap control axis controlled such that the gap amount during machining is maintained constant based on the gap amount detected by the gap sensor, and a machining feed axis that moves the machining head relative to the workpiece such that the machining head moves along a machining shape. The laser beam machine further includes a workpiece detection unit and a gap control unit. When the machining head is moved from a machining end point to a next machining start point, the workpiece detection unit moves the gap control axis by a predetermined amount in a direction in which the machining head moves away from the workpiece, at the machining end point, and then detects presence of the workpiece based on a signal from the gap sensor when an operation to bring the machining head closer to the workpiece is performed. And The gap control unit controls the gap control axis using gap control when the workpiece is detected by the workpiece detection unit.

The machining feed axis may contain a rotation axis that fixes and rotates the workpiece.

According to the present invention, a laser beam machine capable of preventing a collision of a machining head with workpiece when a height direction of the workpiece to be machined is different or when the workpiece mounted on a rotation axis is machined can be provided.

### BRIEF DESCRIPTION OF THE DRAWINGS

The above and other objects and features of the present invention will become apparent from the description of embodiments below with reference to appended drawings. Among these diagrams:

FIG. 1 is a diagram illustrating a first mode of a laser beam machining method by a laser beam machining apparatus according to the present invention;

FIG. 2 is a diagram illustrating a second mode of the laser beam machining method by the laser beam machining apparatus according to the present invention;

FIG. 3 is a block diagram of a first embodiment of a laser beam machine according to the present invention;

FIG. 4 is a block diagram of a second embodiment of the laser beam machine according to the present invention;

FIG. 5 is a diagram illustrating a numerical controller executing the laser beam machining method shown in FIG. 1 and the laser beam machine according to the present invention controlled by the numerical controller;

FIG. 6 is a diagram illustrating the numerical controller executing the laser beam machining method shown in FIG. 2 and the laser beam machine according to the present invention controlled by the numerical controller;

FIG. 7 is a diagram illustrating the laser beam machining method disclosed by Prior Art Document;

FIG. 8 is a diagram illustrating the laser beam machining method according to a conventional technology when a height of workpiece changes at some midpoint; and

FIG. 9 is a diagram illustrating the laser beam machining method according to a conventional technology when the workpiece rotates.

### DETAILED DESCRIPTION OF THE PREFERRED EMBODIMENTS

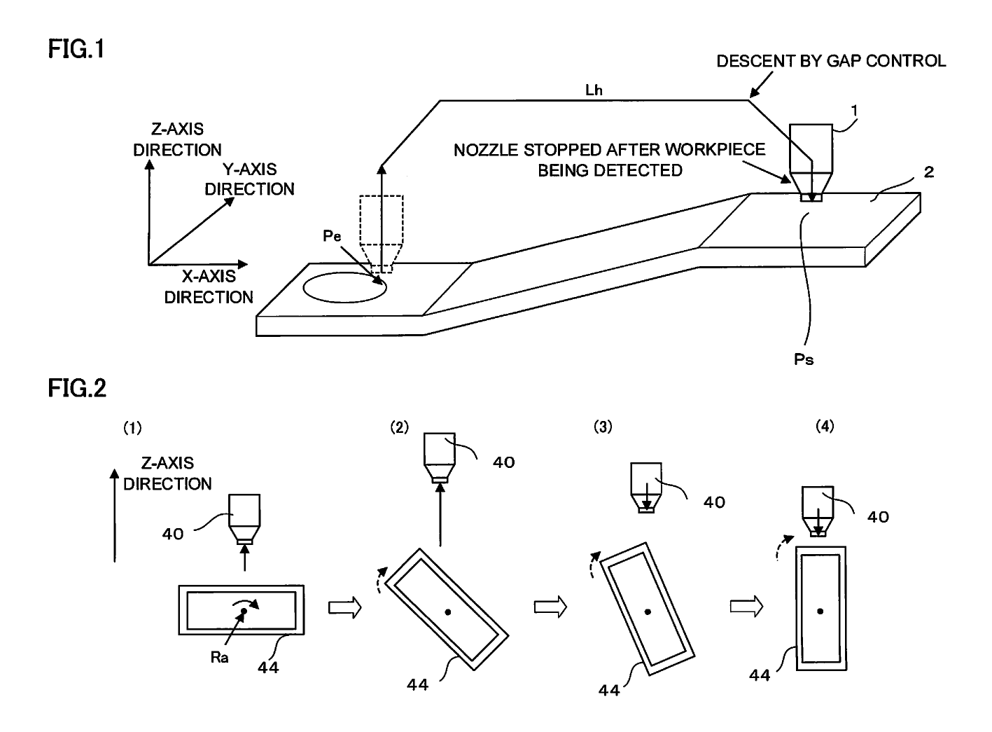

First, a first mode of a laser beam machining method by a laser beam machining apparatus according to the present invention will be described using FIG. 1.

When a workpiece 44 in which a next machining start point Ps is positioned higher than a machining end point Pe is machined with a laser beam, the position of a nozzle is controlled such that the distance to the workpiece 44 is maintained constant by performing a machining operation using gap control and thus, the nozzle of a machining head 40 can be prevented from colliding with the workpiece.

The machining head 40 is lifted in the Z-axis direction at the machining end point Pe in the workpiece 44. When the machining head 40 is lifted by a predetermined distance, the plane axes (X and Y axes) are started to be driven to move the machining head 40 toward the next machining start point Ps. When lifted to a preset height, the machining head 40 stops to move in the Z-axis direction and transitions to movement of only the plane axes (X and Y axes). The machining head 40 starts to descend when detected that the machining head 40 has reached the vicinity of the next machining start point Ps from a remaining amount of movement of a block that issues a command to drive the plane axes.

Next, a second mode of the laser beam machining method by the laser beam machining apparatus according to the present invention will be described using FIG. 2.

When a machining surface is changed in pipe machining, the machining head 40 automatically performs retreating and return operations with only a positioning command to the rotation axis.

(1) Retreat the machining head 40 by a set amount of movement.
(2) Start a positioning command of a rotation axis Ra while retreating the machining head 40 to a set position.
(3) When positioning command of the rotation axis Ra approaches an end point, the descent of the machining head 40 is started. Then, when a gap sensor (not shown) detects workpiece, control is switched to control by the gap control. By switching to control by the gap control, a collision of the machining head 40 with the workpiece is avoided.
(4) Carry out control by the gap control.

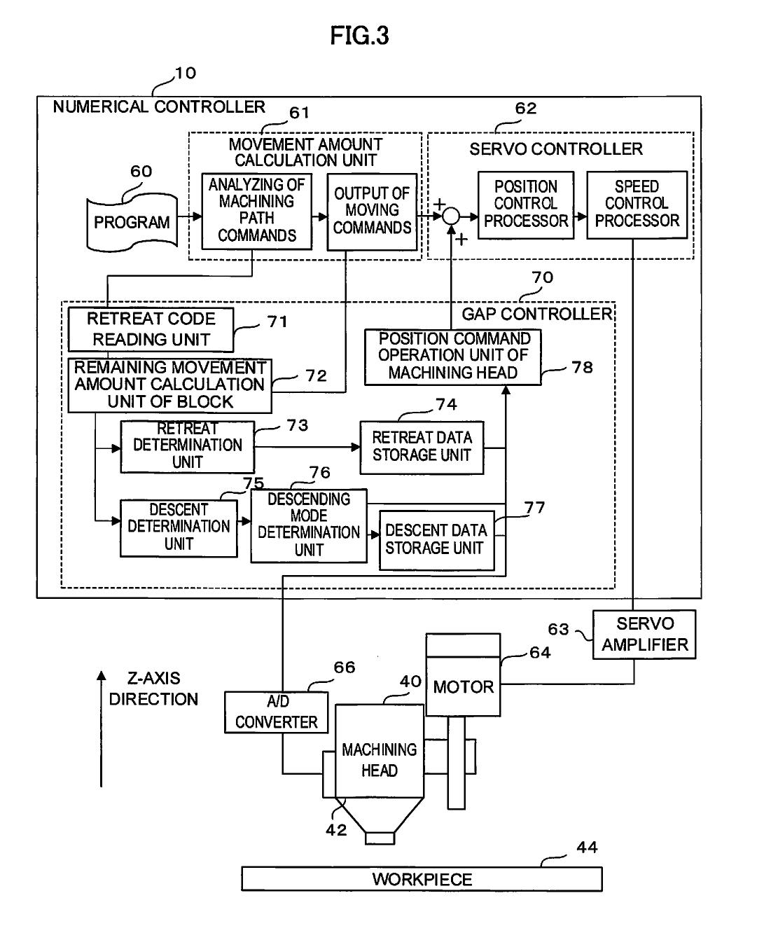

A first embodiment of a laser beam machine according to the present invention will be described using FIG. 3.

A numerical controller 10 that controls a laser beam machine includes a movement amount calculation unit 61, a servo controller 62, and a gap controller 70. The movement amount calculation unit 61 analyzes machining path commands described in a program 60 commanding laser beam machining and outputs moving commands obtained by analysis to the servo controller 62. The servo controller 62 performs processing of position control and speed control and outputs a current command to a servo amplifier 63. The servo amplifier 63 drives a servo motor 64 according to commands from the servo controller 62. The machining head 40 moves vertically in the Z-axis direction according to driving of the servo motor 64.

A gap sensor 42 to measure the distance between the machining head 40 and the workpiece 44 is mounted on the machining head 40. A signal output from the gap sensor 42 is converted into a digital signal by an A/D converter 66 and inputted to a position command operation unit 78 of a machining head of the gap controller 70.

The gap controller 70 includes a retreat code reading unit 71, a block remaining-movement-amount calculation unit 72, a retreat determination unit 73, a retreat data storage unit 74 that stores retreat data preset as a parameter to retreat the machining head, a descent determination unit 75, a descending mode determination unit 76, a descent data storage unit 77 that stores descent data preset as a parameter to cause the machining head 40 to machine, and a position command operation unit 78 of the machining head.

When command code to retreat the machining head to move to the next machining start point is analyzed by analysis of the machining path by the movement amount calculation unit 61, the retreat code reading unit 71 reads the analyzed retreat code. When the retreat code to retreat the machining head is read by the retreat code reading unit 71, the block remaining-movement-amount calculation unit 72 starts to calculate a remaining movement amount of the block.

Here, the remaining movement amount of the block will be described. The movement of the machining head 40 is started according to a positioning command that commands the movement to the next machining point. Then, the block remaining-movement-amount calculation unit 72 calculates a remaining movement amount of the block by integrating moving commands output from the movement amount calculation unit 61. The remaining movement amount of the block is an amount obtained by adding a delay of the motor to an amount corresponding to the distance from the current position of the machining head 40 to the machining start point commanded by a positioning command.

When the calculation of the remaining movement amount of the block is started by the block remaining-movement-amount calculation unit 72, the retreat determination unit 73 outputs retreat data preset as a parameter to retreat the machining head 40 and stored in the retreat data storage unit 74 to the position command operation unit 78 of the machining head.

When the remaining movement amount of the block calculated by the block remaining-movement-amount calculation unit 72 falls below a preset value, the descent determination unit 75 issues a command to the descending mode determination unit 76 to
output descent data, previously set as a parameter and stored in the descent data storage unit 77, to the position command operation unit 78 of the machining head, or
output a command that carries out position control based on a signal from the gap sensor 42 to bring the machining head 40 closer to the workpiece 44, based on output from the gap sensor 42, to the position command operation unit 78 of the machining head.

Which mode of control based on descent data or control based on a signal output from the gap sensor 42 to select may be set in advance in the descending mode determination unit 76 or specified by retreat code which is read into the retreat code reading unit 71.

The position command operation unit 78 of the machining head operates a position command of the machining head 40 to carry out position control of the machining head 40 based on any one of retreat data input from the retreat data storage unit 74, descent data input from the descent data storage unit 77, and data obtained by converting a signal output from the gap sensor 42 by the A/D converter 66.

When performing an operation in the Z-axis direction to bring the machining head 40 closer to the workpiece 44, the position command operation unit 78 of the machining head avoids a collision with the workpiece 44 by switching to gap control when the gap sensor 42 detects the workpiece 44. At this point, whether to perform an operation to bring the machining head 40 closer to the workpiece 44 by the gap control (detection value of the gap sensor 42) or perform an operation to bring the machining head 40 closer to the workpiece 44 up to a position determined by parameter can be selected (switched) by adding a switching unit by the mode to the position command operation unit 78 of the machining head.

For example, the position command operation unit 78 of the machining head
outputs a position command of the machining head 40 based on retreat data to the servo controller 62 when the retreat data is input from the retreat data storage unit 74,
outputs a position command of the machining head based on descent data to the servo controller 62 when the descent data is input from the descent data storage unit 77, or
outputs a position command of the machining head based on data obtained by converting a signal output from the gap sensor 42 by the A/D converter 66 to the servo controller 62 when a gap control command is input from the descending mode determination unit 76.

According to the present invention, when an operation in the Z-axis direction to bring the machining head 40 closer to the workpiece 44 is performed, a collision with the workpiece 44 is avoided by switching to the gap control when the workpiece 44 is detected by the gap sensor 42. At this point, whether to perform an operation to bring the machining head 40 closer to the workpiece 44 by the gap control (detection value of the gap sensor 42) or perform an operation to bring the machining head 40 closer to the workpiece 44 up to a position determined by parameter is selected (switched) by adding a switching unit by the mode. Accordingly, the machining head can descend quickly to a parameter setting value when the workpiece is flat and can descend safely when the workpiece has a special shape such as pipe machining.

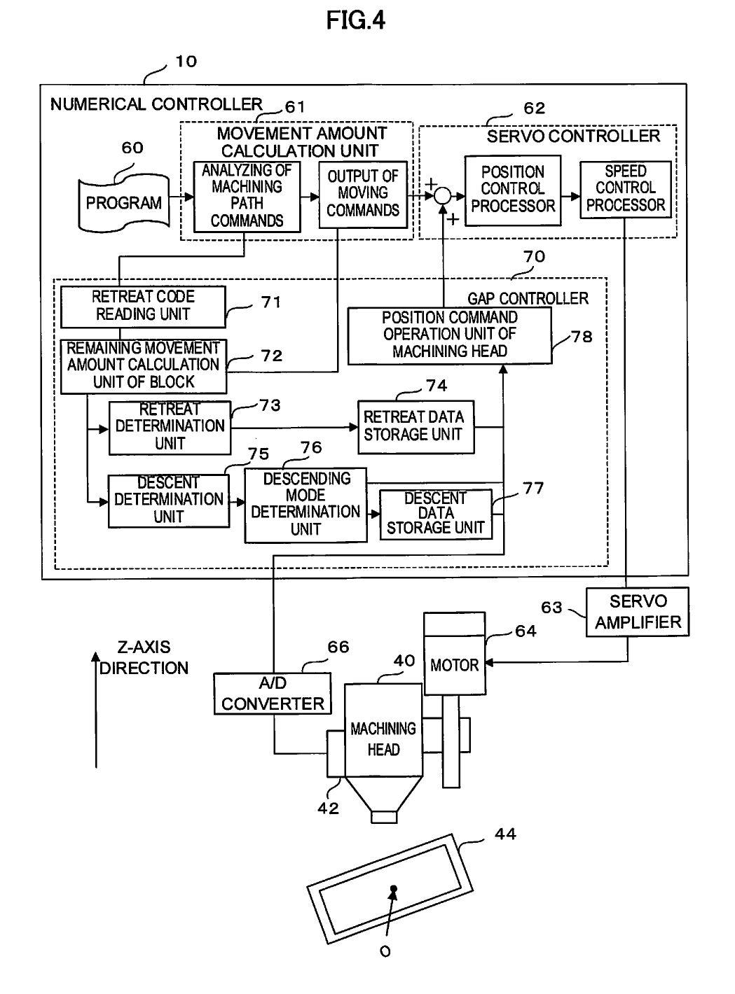

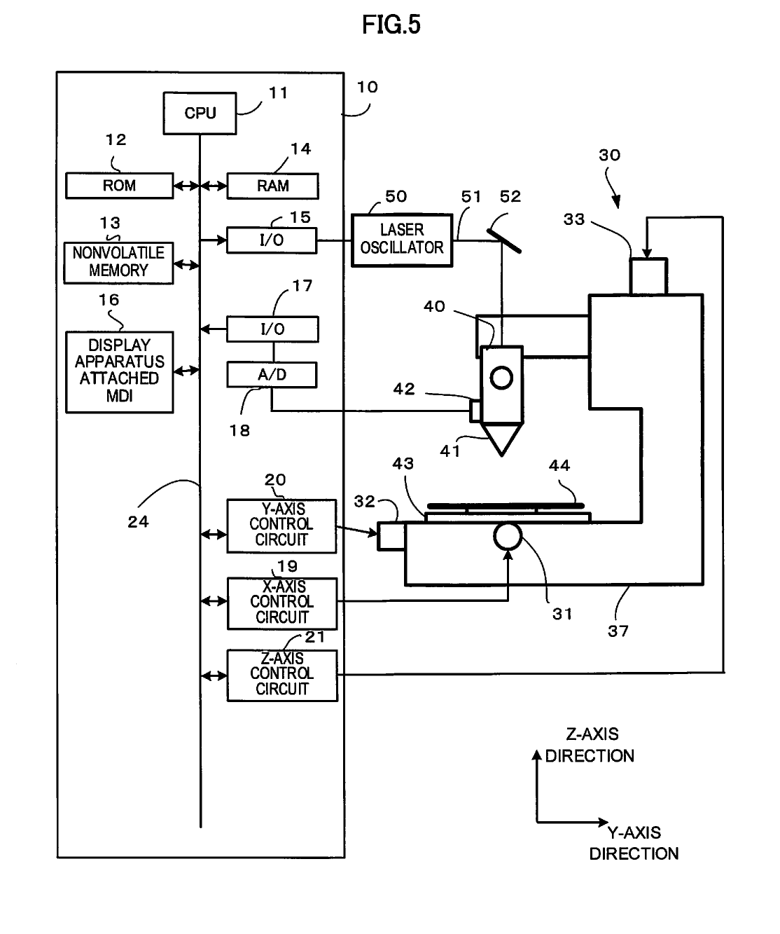

A second embodiment of the laser beam machine according to the present invention will be described using FIG. 4. The laser beam machine includes a mechanism that allows workpiece to rotate around the rotation axis (rotation center O).

The conventional technology can be used even for workpiece of a special shape such as pipe machining by applying the first mode (FIG. 1) of the above laser beam machining method to the case of a positioning command of any third axis, and cycle time can be abbreviated.

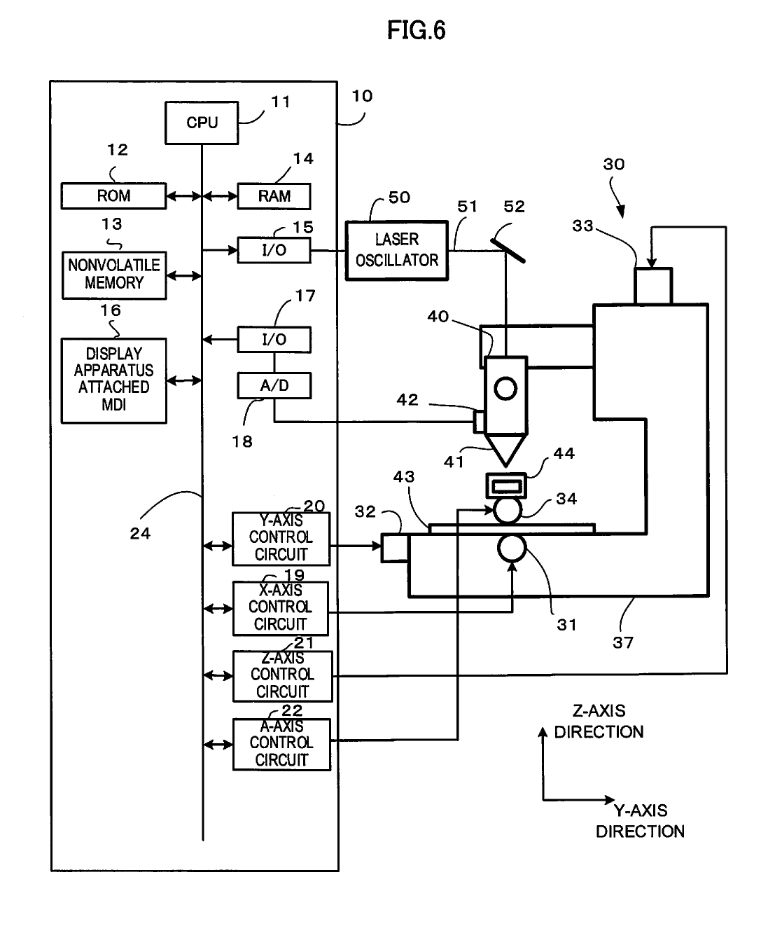

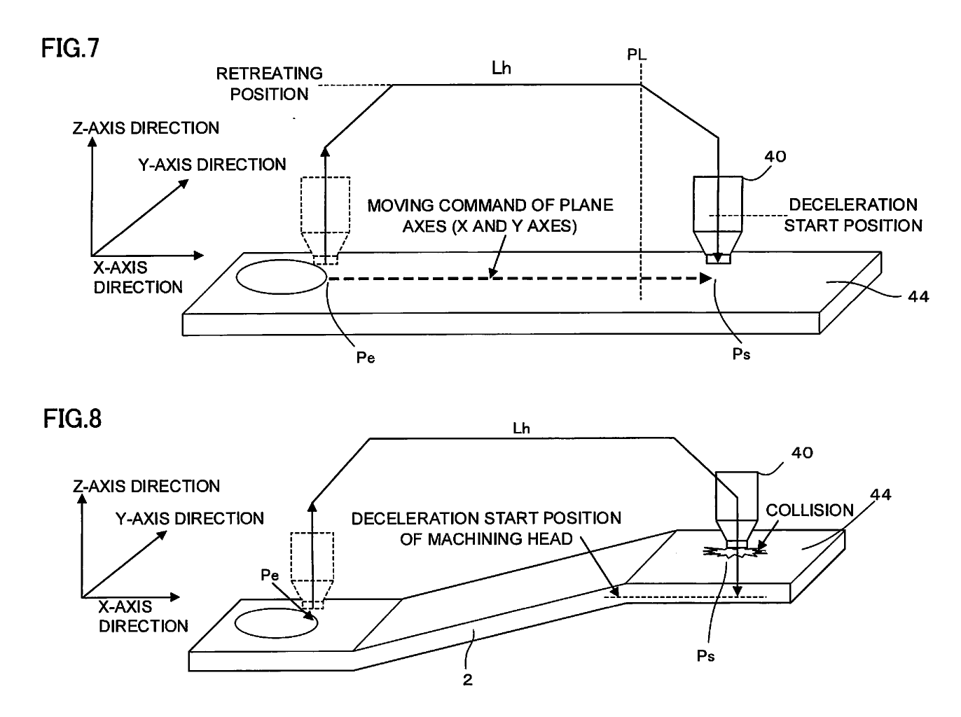

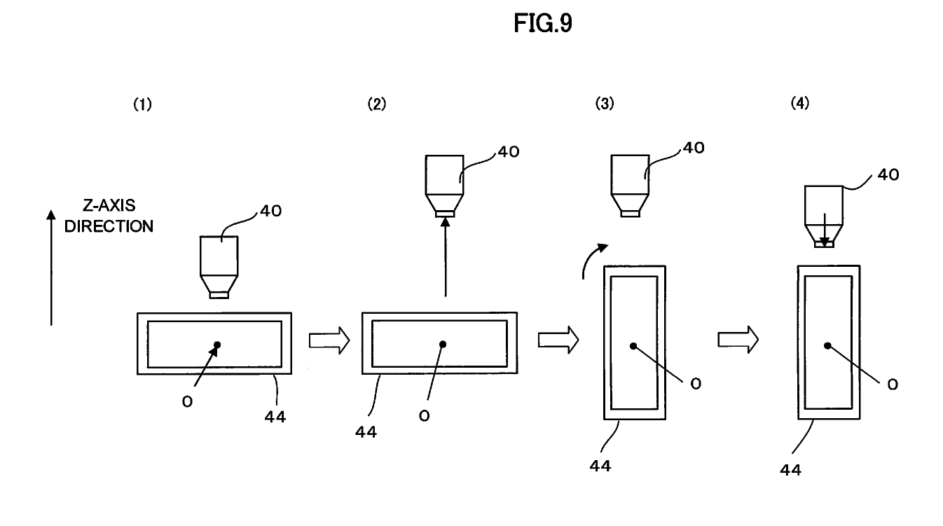

Next, a control apparatus of a laser beam machine that carries out control of the first mode (FIG. 1) and the second mode (FIG. 2) of the above laser beam machining method will be described using FIGS. 5 and 6.

First, a first form of a numerical controller that controls a laser beam machine according to the present invention will be described using FIG. 5.

The control apparatus that controls the laser beam machine is configured by the numerical controller 10. The numerical controller 10 is configured around a processor (CPU) 11 and the processor 11 is connected, via a bus 24, to a ROM 12, a RAM 14, a nonvolatile memory 13 configured by battery backed up SRAM, input/output interfaces 15, 17, a display apparatus attached MDI (manual data input apparatus) 16, axis control circuits 19, 20 of the X and Y axes of a machining feed axis, and an axis control circuit 21 of the Z axis of a gap control axis. Further, the axis control circuits 19 to 21 are connected to axis servo motors 31 to 33 via a servo amplifier (not shown), respectively.

A system program that controls a laser beam machine 30 as a whole is stored in the ROM 12. In the nonvolatile memory 13, a machining program created by using the display apparatus attached MDI 16 or a machining program input via an input interface (not shown) is stored.

The RAM 14 is used for temporary storage of data during various kinds of processing or the like. A laser oscillator 50 is connected to the input/output interface 15 to send an output control signal from the processor 11 to the laser oscillator 50 via the input/output interface 15. A laser beam 51 is emitted by the laser oscillator 50 according to the output control signal and reflected by a bending mirror 52 and then sent to the machining head 40. The laser beam 51 is collected by the machining head 40 and then the workpiece 44 is irradiated therewith from the tip of a torch 41 mounted on the machining head 40.

The torch 41 of the machining head 40 is provided with the gap sensor 42 that measures the distance (gap) between the tip point of the torch 41 and the workpiece 44. An output signal of the gap sensor 42 is output to the input/output interface 17 via an A/D converter (converter that converts an analog signal into a digital signal) 18 inside the numerical controller 10.

A laser beam machine mechanism unit 37 includes the X-axis servo motor 31 that drives a table 43 on which the workpiece 44 is mounted in the X-axis direction (direction perpendicular to the drawing sheet of FIG. 5), the Y-axis servo motor 32 that drives the table 43 in the Y-axis direction perpendicular to the X-axis direction, and the Z-axis servo motor 33 (constituting a gap control axis) that drives the machining head 40 and the torch 41 in the Z-axis direction perpendicular to the X-axis direction and the Y-axis direction.

The X-axis and Y-axis servo motors 31, 32 are used to drive the table 43 and the Z-axis servo motor 33 is used to adjust the distance (that is, the gap) between the tip point of the torch 41 and the workpiece 44. The X-axis servo motor 31 is connected to an X-axis control circuit 19 of the numerical controller 10, the Y-axis servo motor 32 is connected to a Y-axis control circuit 20, and the Z-axis servo motor 33 is connected to a Z-axis control circuit 21.

In addition, a position/speed detector that detects the position/speed such as a pulse coder is mounted on each of the servo motors 31, 32, 33 of respective axes to give feedback of the position/speed of the servo motors 31, 32, 33 to the control circuits 19, 20, 21 of the respective axes, respectively. The control circuits 19, 20, 21 of respective axes output a moving command of the axis to servo amplifiers of respective axes (not shown) based on commands from the processor (CPU) 11 and feedback signals of the position/speed. The servo amplifiers of respective axes each amplify the moving commands to control the position/speed of the servo motors 31, 32, 33 of respective axes. The control circuits 19, 20, 21 of respective axes further each carries out current control based on a feedback signal from a current detector (not shown).

Next, a second form of the numerical controller that controls the laser beam machine according to the present invention will be described using FIG. 6.

The present numerical controller and the numerical controller in the first form described above (FIG. 5) are different in that the numerical controller in the present form further includes a configuration unit of an A axis containing an A-axis servo motor 34 that rotates the workpiece 44 such as a pipe in the table 43 driven by the X-axis servo motor 31 and the Y-axis servo motor 32.

The X-axis and Y-axis servo motors 31, 32 are used to drive the table 43 and the Z-axis servo motor 33 is used to adjust the distance (that is, the gap) between the tip point of the torch 41 and the workpiece 44 and further, the A-axis servo motor 34 is used to rotate the workpiece 44.

The X-axis servo motor 31 is connected to the X-axis control circuit 19 of the numerical controller 10, the Y-axis servo motor 32 is connected to the Y-axis control circuit 20, and the Z-axis servo motor 33 is connected to the Z-axis control circuit 21. The A-axis servo motor 34 is connected to an A-axis control circuit 22. Incidentally, each servo motor is connected to the control circuit of each axis via a servo amplifier (not shown).

A position/speed detector that detects the position/speed such as a pulse coder is mounted on each of the servo motors 31, 32, 33, 34 of respective axes to give feedback of the position/speed of the servo motors 31, 32, 33, 34 to the control circuits 19, 20, 21, 22 of respective axes, respectively. The control circuits 19, 20, 21, 22 of respective axes each output a moving command of the axis to servo amplifiers of respective axes (not shown) based on commands from the processor (CPU) 11 and feedback signals of the position/speed and the servo amplifiers of respective axes each amplify the moving command to control the position/speed of the servo motors 31, 32, 33, 34 of respective axes. The control circuits 19, 20, 21, 22 of respective axes further each carry out current control based on a feedback signal of a current detector (not shown).

1. A laser beam machine comprising:
a gap sensor that detects a gap amount between a machining head and workpiece;
a gap control axis controlled such that the gap amount during machining is maintained constant based on the gap amount detected by the gap sensor; and
a machining feed axis that moves the machining head relative to the workpiece such that the machining head moves along a machining shape,
the laser beam machine, further including:
a workpiece detection unit that moves, when the machining head is moved from a machining end point to a next machining start point, the gap control axis by a predetermined amount in a direction in which the machining head moves away from the workpiece, at the machining end point, and then detects presence of the workpiece based on a signal from the gap sensor when an operation to bring the machining head closer to the workpiece is performed; and
a gap control unit that controls the gap control axis using gap control when the workpiece is detected by the workpiece detection unit.

2. The laser beam machine according to claim 1, wherein the machining feed axis contains a rotation axis that fixes and rotates, the workpiece.
